(19) United States
(12) Patent Application Publication
(10) Pub. No.: US 2026/0146866 A1
(43) Pub. Date: May 28, 2026

(54) SYSTEMS AND METHODS FOR LOCALIZING A VEHICLE ON A MAP

(71) Applicant: Toyota Jidosha Kabushiki Kaisha, Aichi-ken (JP)

(72) Inventor: Alexander C. Schaefer, Fremont, CA (US)

(73) Assignee: Toyota Jidosha Kabushiki Kaisha, Aichi-ken (JP)

(21) Appl. No.: 18/956,173

(22) Filed: Nov. 22, 2024

(51) Int. Cl. G01C 21/00

(52) U.S. Cl. CPC G01C 21/3848

(57) ABSTRACT

In one embodiment, a method of localizing a vehicle on a map includes receiving map data having a first road with a first number of lanes and a second road with a second number of lanes, receiving sensor data from one or more sensors of the vehicle, and receiving a vehicle localization signal. The method further includes generating, from the sensor data, a local map having a local map number of lanes for vehicle localization signal, and localizing the vehicle on the first road or the second road based at least in part on the local map number of lanes for the vehicle localization signal, the first number of lanes, and the second number of lanes.

### BACKGROUND

High definition (HD) maps contain a significant amount of information and are highly accurate. HD maps are captured using lidar, cameras, radar, GPS and the like. HD maps typically include detailed information, such as lane information. These HD maps are used by autonomous vehicles to navigate the environment.

On the other hand, a standard definition (SD) map has basic information regarding road location, intersections, and other information. A majority of mapping information available today is in the form of SD maps. Another type of map is an enhanced SD map that includes all of the information of an SD map with the addition of lane information, such as the number of lanes. Although HD maps provide great value, they are large in size, expensive to develop, and not always available.

Global navigation satellite system (GNSS) measurements (i.e., global positioning system (GPS) measurements) can be noisy and not always accurate. For example, a GNSS measurement may indicate that a vehicle is several meters off of a road when in fact the vehicle is traveling on the road. The noisiness of GNSS signals make it very difficult for the control system of the vehicle to localize the vehicle on the map, and particularly an SD map wherein the detailed information of an HD map is not available. For example, the vehicle may be localized on the wrong road of the map, particularly when there is an intersection, or when there are roads adjacent to one another. It may also be difficult in environments where GNSS signals are particularly noisy, such as in urban environments.

Accordingly, alternative systems and methods for localizing a vehicle on a map may be desired.

### BRIEF SUMMARY

In one embodiment, a method of localizing a vehicle on a map includes receiving map data having a first road with a first number of lanes and a second road with a second number of lanes, receiving sensor data from one or more sensors of the vehicle, and receiving a vehicle localization signal. The method further includes generating, from the sensor data, a local map having a local map number of lanes for the vehicle localization signal, and localizing the vehicle on the first road or the second road based at least in part on the local map number of lanes for the vehicle localization signal, the first number of lanes, and the second number of lanes.

In another embodiment, a vehicle includes one or more processors, one or more sensors, and a non-transitory memory storing instructions that, when executed by the one or more processors, configure the vehicle to receive map data including a first road having a first number of lanes and a second road having a second number of lanes, receive sensor data from the one or more sensors of the vehicle, receive a vehicle localization signal, generate, from the sensor data, a local map that includes a local map number of lanes for the vehicle localization signal, and localize the vehicle on the first road or the second road based at least in part on the local map number of lanes for the vehicle localization signal, the first number of lanes, and the second number of lanes.

In another embodiment, a computing apparatus includes one or more processors and a non-transitory memory storing instructions that, when executed by the one or more processors, configure the computing apparatus to receive map data including a first road having a first number of lanes and a second road having a second number of lanes, receive sensor data from one or more sensors of a vehicle, receive a vehicle localization signal, generate, from the sensor data, a local map includes a local map number of lanes for the vehicle localization signal, and localize the vehicle on the first road or the second road based at least in part on the local map number of lanes for the vehicle localization signal, the first number of lanes, and the second number of lanes.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an environment having an intersection of roads.

FIG. 2 illustrates an example enhanced standard definition map of the intersection depicted by FIG. 1 according to one or more embodiments described and illustrated herein.

FIG. 3 illustrates an example vehicle according to one or more embodiments described and illustrated herein.

FIG. 4 illustrates the enhanced standard definition map of FIG. 2 with local map information also provided according to one or more embodiments described and illustrated herein.

FIG. 5 illustrates example components of a vehicle capable of performing the functionality of localizing the vehicle on a map according to one or more embodiments described and illustrated herein.

FIG. 6 illustrates an example method for localizing a vehicle on a map according to one or more embodiments described and illustrated herein.

### DETAILED DESCRIPTION

Embodiments of the present disclosure are directed to solving the problem of localizing a vehicle on a map when the global navigation satellite system (GNSS) information is noisy and the proper localization of the vehicle is ambiguous. The accuracy of GNSS locations derived from GNSS signals may be low, particularly in urban settings where GNSS signals are known to bounce off of buildings and cause errors in location. This can cause the vehicle to be localized on the map at an incorrect location or road. For example, a vehicle may be traveling on a road close to a highway, but the GNSS location that is generated may place the vehicle on the highway rather than the road the vehicle is actually on. This can cause the vehicle to be localized on the wrong road in a navigation system and/or an autonomous driving system. Localizing the vehicle on the wrong road can create incorrect navigational guidance and/or incorrect autonomous control of the vehicle.

Generally, embodiments provide systems and methods for increasing the accuracy of localizing a vehicle on the correct road by generating local maps using sensor data of the vehicle. The vehicle receives vehicle location signals (i.e., GNSS signals) and generates a plurality of GNSS locations over time as the vehicle travels. For each GNSS location, the vehicle generates a local map using sensor data, such as camera data. The local map includes the number of lanes, the lane direction, the lane width, the lane curvature, speed limit, as not limiting examples. For example, image data is used to detect the number of lanes in the road in which the vehicle is traveling. The number of lanes is provided in the local map for the particular GNSS location. The number of lanes in the local map is compared with the number of lanes in an enhanced standard definition (SD) map having lane information. The vehicle is then localized on the enhanced SD map on a road that has a number of lanes that most closely matches, or exactly matches, the number of lanes provided by the local map of the GNSS location.

Accordingly, embodiments provide additional information that allows the vehicle to more accurately be localized on a map, particularly in environments where the GNSS signal is noisy.

Various embodiments of systems, methods, and vehicles for localizing a vehicle on a map are described in detail below.

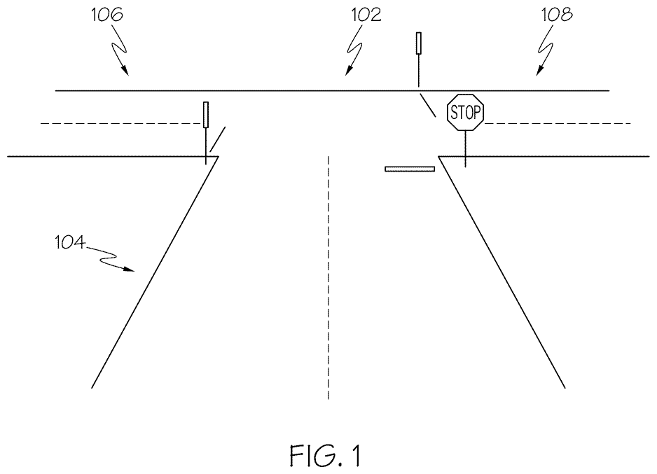

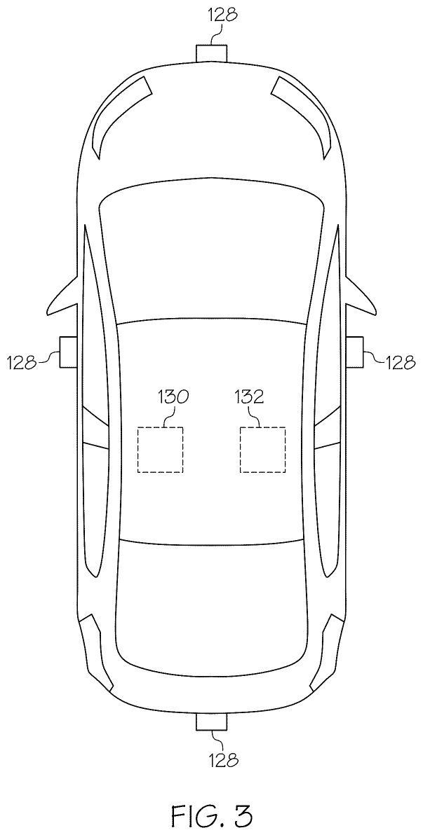

Referring now to FIG. 1, an example vehicular environment includes an intersection 102 where a first road 104, a second road 106 and a third road 108 meet. The second road 106 and the third road 108 may define a single road that intersects with the first road 104, for example. When a vehicle approaches the intersection 102 from the first road 104, there is the option to turn right onto the third road 108 or to turn left onto the second road 106. It should be understood that the environment illustrated by FIG. 1 is for illustrative purposes only, and that embodiments of the present disclosure may be utilized in any intersection configuration. The vehicle 126 may be a driver-controlled vehicle, a semi-autonomous vehicle, or an autonomous vehicle. An example vehicle 126 is illustrated in FIG. 3 and described in more detail below. Such a vehicle 126 includes a GNSS device 130, such as a GPS transceiver, that receive GNSS signals that define a location of the vehicle. However, as stated above, such GNSS signals may be noisy and not accurate.

In some embodiments, the vehicle uses not only GNSS information for localization, but also other information generated by other sensors of the vehicle in vehicle location signal. For example, the vehicle may use GNSS signals, odometry information, and inertial measurement unit (IMU) signals from IMU sensors. Further, in some embodiments the vehicle generates a vehicle location signal by estimation without using a GNSS signal. It should be understood that embodiments are described herein in the context of using GNSS signals, embodiments may use a vehicle location signal that may or may not use GNSS signals.

The vehicle 126 includes a mapping function whereby map data is loaded onto the memory of the vehicle 126 or provided remotely by a remote server. The map data may define an enhanced SD map that includes the number of lane lines.

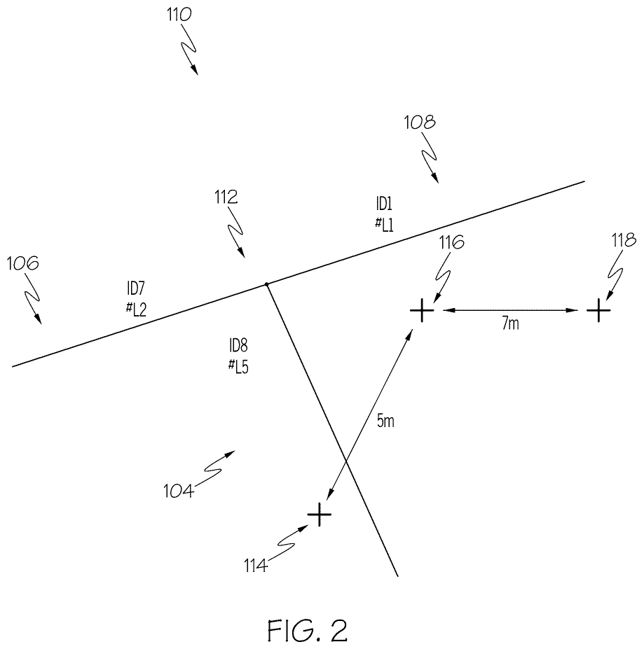

Referring now to FIG. 2, an example map 110 of the intersection 102 illustrated by FIG. 1 is provided. The first road 104, the second road 106 and the third road 108 are represented by road segments (i.e., lines) that meet at the intersection 102. In the illustrated embodiment, each road segment of the map 110 includes lane information in the form of an identification number (ID) and the number of lanes for each road segment. The first road 104 has an ID of 8 and five lanes, the second road 106 has an ID of 7 and two lanes, and the third road 108 has an ID of 1 and one lane.

As the vehicle 126 traverses the first road 104, it receives a plurality of GNSS signals providing a plurality of GNSS locations. As shown in FIG. 2, the vehicle 126 generated a first GNSS location 114 from a first GNSS signal, a second GNSS location 116 from a second GNSS signal, and a third GNSS location 118 from a third GNSS signal. These GNSS locations are generated sequentially over time. Distance information between the GNSS locations is also available. For example, the first GNSS location 114 and the second GNSS location 116 are separated by 5 m, and the second GNSS location 116 and the third GNSS location 118 are separated by 7 m.

None of the GNSS locations shown in FIG. 2 are directly positioned on a road. Accordingly, the confidence of localizing the vehicle 126 on any of the first road 104, the second road 106 and the third road 108 is low. The GNSS signals may provide an accuracy of 20 m or higher, for example. In such a scenario, each GNSS location could be associated with any one of the first road 104, the second road 106 and the third road 108; however, there is not enough information for the vehicle 126 to be localized on the correct road in the map.

Referring now to FIG. 3, an example vehicle 126 is illustrated. The vehicle 126 may be a manually driven vehicle (i.e., a human-operated vehicle), a semi-autonomous vehicle having some autonomous functions (e.g., Level 2 autonomous vehicle), a fully autonomous vehicle (e.g., Level 5 autonomous vehicle), and the like. The example vehicle 126 includes a plurality of sensors 128, which may be cameras, proximity sensors, lidar sensors, radar sensors, and combinations thereof. The sensors 128 produce sensor data regarding the environment, such as roads. In some embodiments, the sensor data includes video data generated from camera sensors. The video data includes images of the road such that the vehicle 126 can determine the number of lanes of the road it is traveling on. The vehicle 126 includes one or more processors 132 that are configured to receive the sensor data (e.g., video and/or image data of the road) and detect the number of lanes. The vehicle 126, using the one or more processors, creates a local map of the road that the vehicle 126 is traveling on that includes the number of lanes.

The vehicle further includes a GNSS device 130, such as a GPS transceiver, that receives GNSS signals from satellites and stores, in a memory device, the GNSS locations of the GNSS signals.

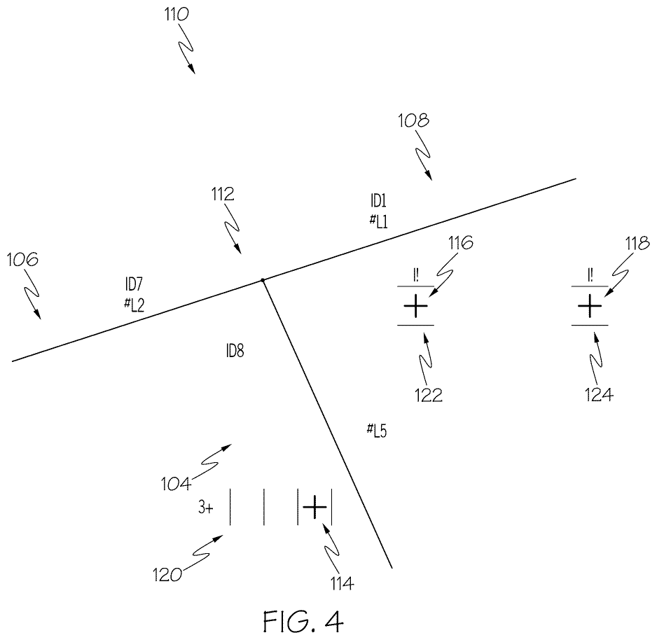

In embodiments of the present disclosure, the vehicle 126 uses both the lane information from local maps derived from sensor data and lane information from the enhanced SD map 110. Referring to FIG. 4, each GNSS location has a local map 120 associated therewith. The first GNSS location 114 has a local map showing that there are at least three lanes on the road the vehicle 126 is traveling, as illustrated by the four parallel lines representing lanes and the text “3+”. Therefore, there are at least three lanes (and maybe more) on the road the vehicle 126 is traveling at the first GNSS location 114 as detected by the sensors 128 of the vehicle 126.

The second GNSS location 116 has a local map 122 showing that there is exactly one lane on the road that the vehicle 126 is traveling, as illustrated by the two parallel lines proximate the second GNSS location 116 and the text “1!”, where the exclamation point represents the word “exact.” Therefore, there is exactly one lane on the road the vehicle 126 is traveling at the second GNSS location 116 as detected by the sensors 128 of the vehicle 126.

The third GNSS location 118 has a local map 124 showing that there is exactly one lane on the road that the vehicle is traveling, as illustrated by the two parallel lines proximate the third GNSS location 118 and the text “1!”. Therefore, there is exactly one lane on the road the vehicle 126 is traveling at the third GNSS location 118 as detected by the sensors of the vehicle 126.

The vehicle 126 uses both the lane information from the local maps as shown in FIG. 4 and the lane information from the enhanced SD map 110. For example, the vehicle 126 compares the lane information from the local maps associated with the GNSS locations with the lane information of the enhanced SD map 110. In the example of FIG. 4, the number of lanes of local map 120 (i.e., the “local map number of lanes”) associated with the first GNSS location 114 is compared with the number of lanes of each road in the map within a radius of the first GNSS location 114. Here, there are at least three local map lanes for the first GNSS location 114 and the first road 104 having ID8 has the closest number of lanes to at least three lanes of local map 120. Therefore, the first road 104 having ID8 is selected and the vehicle 126 is localized on the first road.

The local map number of lanes of local map 120 associated with the second GNSS location 116 is compared with the number of lanes of each road in the map within the radius of the second GNSS location 116. There is exactly one lane for the second GNSS location 116 and, because the third road 108 having ID1 is the only road having one lane, it is selected and the vehicle is localized on the third road having ID1. Similarly, the local map number of lanes for local map 124 associated with the third GNSS location 118, which causes the vehicle 126 to localize itself on the third road 108 having ID1.

The comparison of the local map number of lanes with the number of lanes in each road may be used in a heuristics approach as described above. However, such lane information and comparison may be used in probabilistic methods of localization, such as particle filters and Hidden Markov Models, as non-limiting examples.

Thus, embodiments of the present disclosure compare lane information from local maps to lane information of an enhanced SD map to localize the vehicle 126 on the enhanced SD map. This additional information is useful in properly localizing the vehicle 126 on the correct road, particularly in areas where the GNSS signals are noisy, such as urban locations.

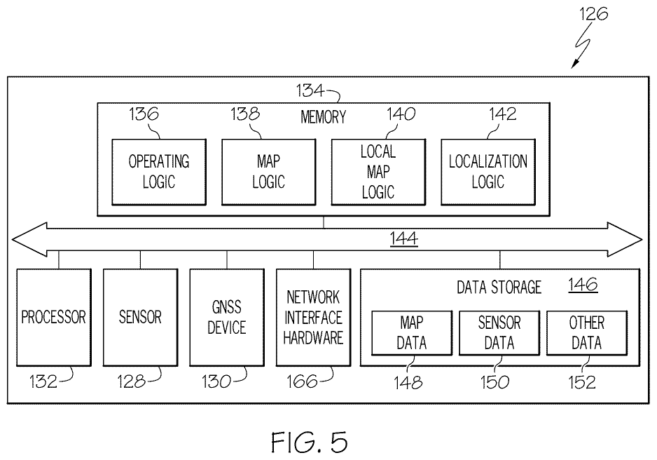

Referring now to FIG. 5, an example system of a vehicle 126 for localizing a vehicle on a map is schematically illustrated. The example vehicle 126 provides a system for localizing a vehicle on a map, and/or a non-transitory computer usable medium having computer readable program code for localizing a vehicle on a map embodied as hardware, software, and/or firmware, according to embodiments shown and described herein. It should be understood that the software, hardware, and/or firmware components depicted in FIG. 5 may also be provided in other computing devices external to the vehicle 126 (e.g., data storage devices, remote server computing devices, and the like).

As also illustrated in FIG. 5, the vehicle 126 (or other additional computing devices) may include a processor 132, one or more sensors 128, one or more GNSS devices 130, network interface hardware 166, and a data storage component 146 (which may store map data 148, sensor data 150, and any other data 152 for performing the functionalities described herein), and a non-transitory memory component 134. The non-transitory memory component 134 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 134 may be defined by transitory memory and/or signals.

Additionally, the memory component 134 may be configured to store operating logic 136, map logic 138 for rendering map data 148, local map logic 140 for receiving sensor data and GNSS signals, and generating local maps for GNSS locations, and localization logic for localizing the vehicle on the map (each of which may be embodied as computer readable program code, firmware, or hardware, as an example). It should be understood that the data storage component 146 may reside local to and/or remote from the vehicle 126, and may be configured to store one or more pieces of data for access by the vehicle 126 and/or other components.

A local interface 144 is also included in FIG. 5 and may be implemented as a bus or other interface to facilitate communication among the components of the vehicle 126.

The processor 132 may include any processing component configured to receive and execute computer readable code instructions (such as from the data storage component 146 and/or memory component 134). The network interface hardware 166 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 134 may be the operating logic 136, map logic 138, local map logic 140, and localization logic 142. The operating logic 136 may include an operating system and/or other software for managing components of the computing device 1002. The map logic 138 may reside in the memory component 134 and may be configured to receive map data 148 and render or otherwise generate a map (e.g., a map used by autonomous functions of the vehicle and/or display on a display device within the vehicle 126). The local map logic 140 also may reside in the memory component 134 and may be configured to receive sensor data and GNSS signals, generate GNSS locations, and generate a local map for each of the GNSS locations based on the sensor data. The localization logic 142 is configured to analyze the map of the map logic and the local maps of the GNSS locations, and to localize the vehicle 126 on the map based on the lane information of the map and the lane information of the local maps.

The components illustrated in FIG. 5 are merely exemplary and are not intended to limit the scope of this disclosure. More specifically, while the components in FIG. 5 are illustrated as residing within the vehicle 126, this is a non-limiting example. In some embodiments, one or more of the components may reside external to the vehicle 126.

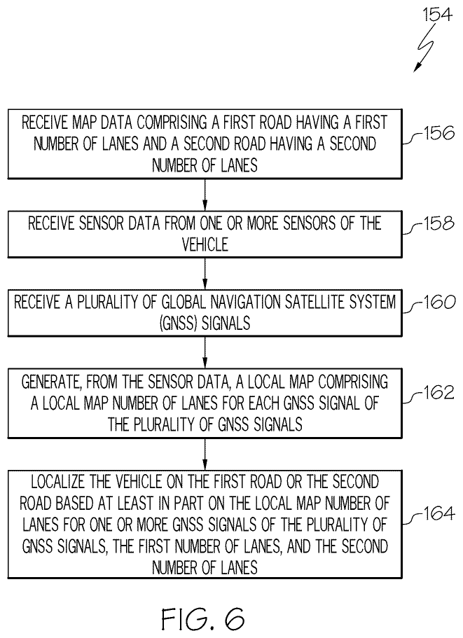

FIG. 6 illustrates an example method 154 of localizing a vehicle on a road. In block 156, the vehicle 126 receives map data comprising a first road having a first number of lanes and a second road having a second number of lanes. However, the map data may include any number of roads. In block 158, the vehicle 126 receives sensor data from one or more sensors of the vehicle. The one or more sensors may be cameras, for example. At block 160, the vehicle 126 receives a plurality of GNSS signals from a GNSS device, such as a GPS device, for example. Next, in block 162, the vehicle 126 generates, from the sensor data, a local map comprising a local map number of lanes for each GNSS signal of the plurality of GNSS signals. Then, in block 164, the vehicle 126 is localized on the first road or the second road based at least in part on the local map number of lanes for one or more GNSS signals of the plurality of GNSS signals, the first number of lanes, and the second number of lanes.

It should now be understood that embodiments provide systems and methods for increasing the accuracy of localizing a vehicle on the correct road by generating local maps using sensor data of the vehicle. The vehicle receives GNSS signals and generates a plurality of GNSS locations over time as the vehicle travels. For each GNSS location, the vehicle generates a local map using sensor data, such as camera data. The local map includes the number of lanes. For example, image data is used to detect the number of lanes in the road in which the vehicle is traveling. The number of lanes is provided in the local map for the particular GNSS location. The number of lanes in the local map is compared with the number of lanes in an enhanced standard definition (SD) map having lane information. The vehicle is then localized on the enhanced SD map on a road that has a number of lanes that most closely matches, or exactly matches, the number of lanes provided by the local map of the GNSS location.

What is claimed is:

1. A method of localizing a vehicle on a map, the method comprising:
receiving map data comprising a first road having a first number of lanes and a second road having a second number of lanes;
receiving sensor data from one or more sensors of the vehicle;
receiving a vehicle location signal;
generating, from the sensor data, a local map comprising a local map number of lanes for the vehicle location signal; and
localizing the vehicle on the first road or the second road based at least in part on the local map number of lanes for the vehicle location signal, the first number of lanes, and the second number of lanes.

2. The method of claim 1, further comprising selecting the first road or the second road for localization based on a comparison between the local map number of lanes for the vehicle location signal, the first number of lanes, and the second number of lanes.

3. The method of claim 1, wherein a difference between the local map number of lanes and first number of lanes and the second number of lanes affects the localization of the vehicle on the map.

4. The method of claim 1, wherein localizing the vehicle on the first road or the second road is further based at least in part on a distance between a location provided by the vehicle location signal, the first road and the second road.

5. The method of claim 1, wherein the vehicle location signal comprises a global navigation satellite system (GNSS) signal.

6. The method of claim 1, wherein the vehicle is localized on the map for each vehicle location signal of a plurality of vehicle location signals.

7. A vehicle comprising:
one or more processors;
one or more sensors; and
a non-transitory memory storing instructions that, when executed by the one or more processors, configure the vehicle to:
receive map data comprising a first road having a first number of lanes and a second road having a second number of lanes;
receive sensor data from the one or more sensors of the vehicle;
receive a vehicle location signal;
generate, from the sensor data, a local map comprising a local map number of lanes for the vehicle location signal; and
localize the vehicle on the first road or the second road based at least in part on the local map number of lanes for the vehicle location signal, the first number of lanes, and the second number of lanes.

8. The vehicle of claim 7, wherein the instructions further configure the vehicle to select the first road or the second road for localization based on a comparison between the local map number of lanes for the vehicle location signal, the first number of lanes, and the second number of lanes.

9. The vehicle of claim 7, wherein a difference between the local map number of lanes and first number of lanes and the second number of lanes affects the localization of the vehicle on the map.

10. The vehicle of claim 7, wherein localizing the vehicle on the first road or the second road is further based at least in part on a distance between a location provided by the vehicle location signal, the first road and the second road.

11. The vehicle of claim 7, wherein the vehicle location signal comprises a global navigation satellite system (GNSS) signal.

12. The vehicle of claim 7, wherein the vehicle is localized on the map for each vehicle location signal of a plurality of vehicle location signals.

13. The vehicle of claim 7, wherein the instructions further configure the vehicle to autonomously navigate based at least in part on the localization of the vehicle on the map.

14. A computing apparatus comprising:
one or more processors; and
a non-transitory memory storing instructions that, when executed by the one or more processors, configure the computing apparatus to:
receive map data comprising a first road having a first number of lanes and a second road having a second number of lanes;
receive sensor data from one or more sensors of a vehicle;
receive a vehicle location signal;
generate, from the sensor data, a local map comprising a local map number of lanes for the vehicle location signal; and
localize the vehicle on the first road or the second road based at least in part on the local map number of lanes for the vehicle location signal, the first number of lanes, and the second number of lanes.

15. The computing apparatus of claim 14, wherein the instructions further configure the computing apparatus to select the first road or the second road for localization based on a comparison between the local map number of lanes for the vehicle location signal, the first number of lanes, and the second number of lanes.

16. The computing apparatus of claim 14, wherein a difference between the local map number of lanes and first number of lanes and the second number of lanes affects the localization of the vehicle on the map.

17. The computing apparatus of claim 14, wherein localizing the vehicle on the first road or the second road is further based at least in part on a distance between a location provided by the vehicle location signal, the first road and the second road.

18. The computing apparatus of claim 14, wherein the vehicle location signal comprises a global navigation satellite system (GNSS) signal.

19. The computing apparatus of claim 14, wherein the vehicle is localized on the map for each vehicle location signal of a plurality of vehicle location signals.

20. The computing apparatus of claim 14, wherein the map is an enhanced standard definition map.
